(19) United States
(12) Patent Application Publication
(10) Pub. No.: US 2017/0241553 A1
(43) Pub. Date: Aug. 24, 2017

(54) Stop Valve

(71) Applicants: Solen Electric Co., Ltd., Taoyuan City (TW); National Craft Industries. Inc., New Taipei City (TW)

(72) Inventors: Hsin-Yu Shu, Taoyuan City (TW); Yen-Ling Yeh, Taoyuan City (TW)

(21) Appl. No.: 15/051,741

(22) Filed: Feb. 24, 2016

(51) Int. Cl. F16K 5/04

(52) U.S. Cl. CPC F16K 5/0478

(57) ABSTRACT

A stop valve includes a valve body having a receiving space, a shaft rotatably mounted in the receiving space of the valve body, and an operation member mounted on the shaft. The shaft has a shaft body and a driven portion. The shaft body is provided with a connecting hole. The shaft body has a periphery provided with two retaining grooves for mounting two seal rings. The two seal rings are directly formed in the two retaining grooves of the shaft body in a secondary molding mode so that the two seal rings and the two retaining grooves of the shaft body have greater strength of combination, such that the two seal rings will not be detached from the two retaining grooves of the shaft body, thereby preventing from incurring fluid leakage.

### BACKGROUND OF THE INVENTION

1. Field of the Invention

The present invention relates to a valve and, more particularly, to a stop valve.

2. Description of the Related Art

A conventional stop valve in accordance with the prior art shown in FIG. 1 comprises a valve body “A” having an interior provided with a receiving space “B”, a shaft “C” rotatably mounted in the receiving space “B” of the valve body “A”, and an operation member “L” mounted on the shaft “C”. The valve body “A” has a first side provided with a first channel “D” connected to the receiving space “B” to allow input of a fluid and a second side provided with a second channel “E” connected to the receiving space “B” to allow output of the fluid. The receiving space “B” of the valve body “A” is disposed between the first channel “D” and the second channel “E”. The valve body “A” has a top provided with an opening “G”. The shaft “C” has a first end provided with a shaft body “H” disposed between the first channel “D” and the second channel “E” of the valve body “A” and a second end provided with a driven portion “F” protruding outward from the opening “G” of the valve body “A”. The shaft body “H” of the shaft “C” has a diameter greater than that of the driven portion “F” and is provided with a connecting hole “I” connected to the first channel “D” and the second channel “E” of the valve body “A”. The shaft body “H” of the shaft “C” has a periphery provided with two retaining grooves “J” for mounting two seal rings “K” which provide an air-tight function between the shaft “C” and the valve body “A” to prevent the fluid from leaking from the gap between the shaft “C” and the valve body “A”. The operation member “L” is mounted on the driven portion “F” of the shaft “C” to drive and rotate the shaft “C” relative to the valve body “A”. However, the seal rings “K” are loosely received in the retaining grooves “J” so that when the fluid passing through the first channel “D” and the second channel “E” of the valve body “A” is under a high pressure, the seal rings “K” are easily detached from the retaining grooves “J” due to flush of the fluid at the high pressure, thereby easily causing a leak. In addition, when the shaft “C” is rotated, the seal rings “K” are easily moved or even broken due to frequent compression of the shaft “C”, thereby easily causing a leak.

### BRIEF SUMMARY OF THE INVENTION

The primary objective of the present invention is to provide a stop valve having an enhanced leakproof function.

In accordance with the present invention, there is provided a stop valve comprising a valve body having an interior provided with a receiving space, a shaft rotatably mounted in the receiving space of the valve body, and an operation member mounted on the shaft. The valve body has a first side provided with a first channel connected to the receiving space and a second side provided with a second channel connected to the receiving space. The valve body has a top provided with an opening. The shaft has a first end provided with a shaft body disposed between the first channel and the second channel of the valve body and a second end provided with a driven portion protruding outward from the opening of the valve body. The shaft body of the shaft is provided with a connecting hole connected to the first channel and the second channel of the valve body. The shaft body of the shaft has a periphery provided with two retaining grooves for mounting two seal rings. The operation member is mounted on the driven portion of the shaft to drive and rotate the shaft relative to the valve body. The two seal rings are directly formed in the two retaining grooves of the shaft body in a secondary molding mode.

Preferably, each of the two retaining grooves of the shaft body has an inner edge provided with a fixing portion protruding toward an inner edge of the connecting hole, and each of the two seal rings is provided with a fixing section corresponding to the fixing portion of each of the two retaining grooves.

According to the primary advantage of the present invention, the two seal rings are directly formed in the two retaining grooves of the shaft body so that the two seal rings and the two retaining grooves of the shaft body have greater strength of combination, such that the two seal rings will not be detached from the two retaining grooves of the shaft body due to flush of the fluid at a high pressure, thereby preventing from incurring fluid leakage.

According to another advantage of the present invention, the two seal rings and the two retaining grooves of the shaft body have greater strength of combination by provision of the fixing portion of each of the two retaining grooves and the fixing section of each of the two seal rings.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view of a conventional stop valve in accordance with the prior art.

FIG. 2 is a perspective view of a stop valve in accordance with the preferred embodiment of the present invention.

FIG. 3 includes front and side views of a shaft of the stop valve in accordance with the preferred embodiment of the present invention.

FIG. 4 is a cross-sectional view of the stop valve as shown in FIG. 2.

### DETAILED DESCRIPTION OF THE INVENTION

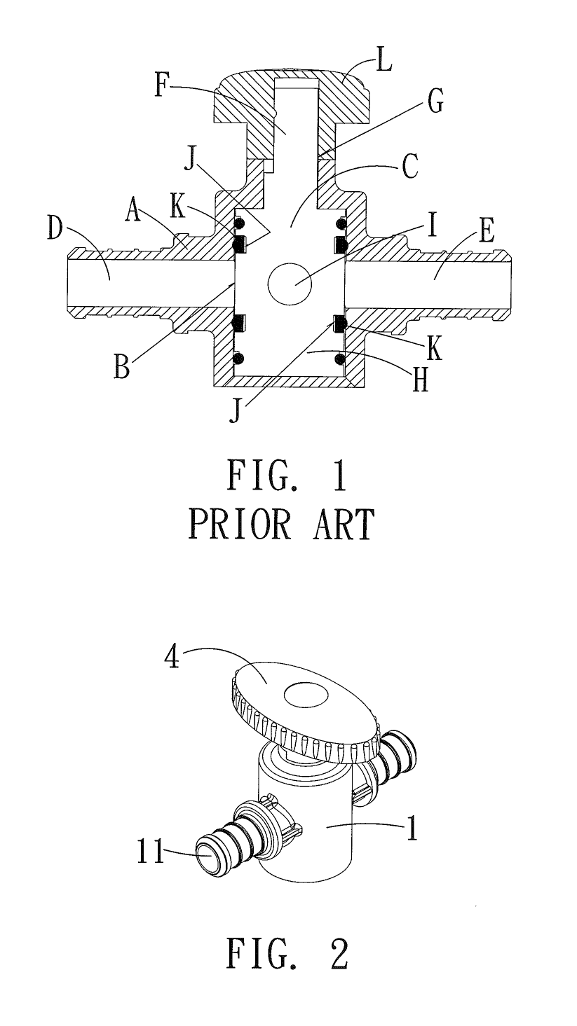

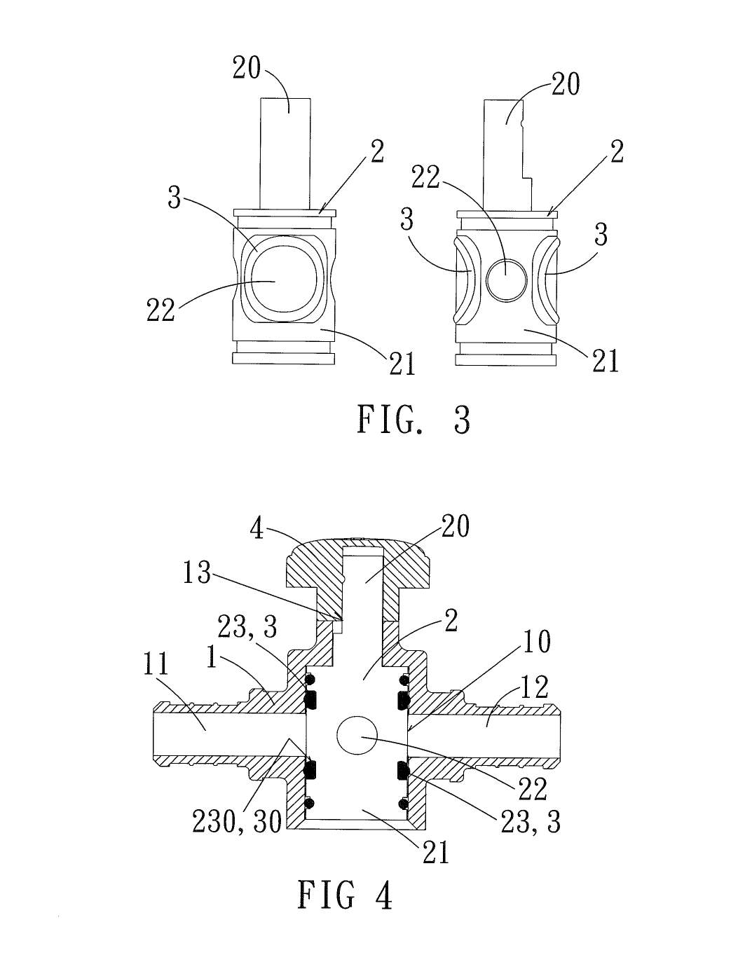

Referring to the drawings and initially to FIGS. 2-4, a stop valve in accordance with the preferred embodiment of the present invention comprises a valve body 1 having an interior provided with a receiving space 10, a shaft 2 rotatably mounted in the receiving space 10 of the valve body 1, and an operation member 4 mounted on the shaft 2.

The valve body 1 has a first side provided with a first channel 11 connected to the receiving space 10 to allow input of a fluid and a second side provided with a second channel 12 connected to the receiving space 10 to allow output of the fluid. The receiving space 10 of the valve body 1 is disposed between the first channel 11 and the second channel 12. The valve body 1 has a top provided with an opening 13.

The shaft 2 has a first end provided with a shaft body 21 disposed between the first channel 11 and the second channel 12 of the valve body 1 and a second end provided with a driven portion 20 protruding outward from the opening 13 of the valve body 1. The shaft body 21 of the shaft 2 has a diameter greater than that of the driven portion 20 and is provided with a connecting hole 22 connected to the first channel 11 and the second channel 12 of the valve body 1. The shaft body 21 of the shaft 2 has a periphery provided with two retaining grooves 23 for mounting two seal rings 3 which provide an air-tight function between the shaft 2 and the valve body 1 to prevent the fluid from leaking from the gap between the shaft 2 and the valve body 1. The connecting hole 22 of the shaft 2 is disposed between the two seal rings 3.

The operation member 4 is mounted on the driven portion 20 of the shaft 2 to drive and rotate the shaft 2 relative to the valve body 1.

When in use, when the operation member 4 is rotated, the shaft 2 is rotated between a first position where the connecting hole 22 is connected to the first channel 11 and the second channel 12 of the valve body 1 to allow the fluid to flow through the first channel 11 of the valve body 1, the connecting hole 22 of the shaft 2 and the second channel 12 of the valve body 1, and a second position where the connecting hole 22 is disconnected from the first channel 11 and the second channel 12 of the valve body 1 as shown in FIG. 4 so as to interrupt the connection between the first channel 11 and the second channel 12 of the valve body 1.

In the preferred embodiment of the present invention, the two seal rings 3 are directly formed in the two retaining grooves 23 of the shaft body 21 in a secondary molding mode. In such a manner, the two seal rings 3 are directly formed in the two retaining grooves 23 of the shaft body 21 so that the two seal rings 3 and the two retaining grooves 23 of the shaft body 21 have greater strength of combination, such that the two seal rings 3 will not be detached from the two retaining grooves 23 of the shaft body 21 due to flush of the fluid at a high pressure, thereby preventing from incurring fluid leakage. In addition, the two seal rings 3 and the two retaining grooves 23 of the shaft body 21 have greater strength of combination, so that the two seal rings 3 will not be moved or broken when the shaft 2 is rotated.

In the preferred embodiment of the present invention, each of the two retaining grooves 23 of the shaft body 21 has an inner edge provided with a fixing portion 230 protruding toward an inner edge of the connecting hole 22, and each of the two seal rings 3 is provided with a fixing section 30 corresponding to the fixing portion 230 of each of the two retaining grooves 23, so that the two seal rings 3 and the two retaining grooves 23 of the shaft body 21 have greater strength of combination by provision of the fixing portion 230 of each of the two retaining grooves 23 and the fixing section 30 of each of the two seal rings 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A stop valve comprising:
a valve body having an interior provided with a receiving space;
a shaft rotatably mounted in the receiving space of the valve body; and
an operation member mounted on the shaft;
wherein:
the valve body has a first side provided with a first channel connected to the receiving space and a second side provided with a second channel connected to the receiving space;
the valve body has a top provided with an opening;
the shaft has a first end provided with a shaft body disposed between the first channel and the second channel of the valve body and a second end provided with a driven portion protruding outward from the opening of the valve body;
the shaft body of the shaft is provided with a connecting hole connected to the first channel and the second channel of the valve body;
the shaft body of the shaft has a periphery provided with two retaining grooves for mounting two seal rings;
the operation member is mounted on the driven portion of the shaft to drive and rotate the shaft relative to the valve body;
the two seal rings are directly formed in the two retaining grooves of the shaft body in a secondary molding mode;
each of the two retaining grooves of the shaft body is provided with a concave fixing portion; and
each of the two seal rings is provided with a convex fixing section pressing the concave fixing portion of each of the two retaining grooves.

2. (canceled)
